(19) United States
(12) Patent Application Publication
(10) Pub. No.: US 2007/0136483 A1
(43) Pub. Date: Jun. 14, 2007

(54) Image forming device to create a passcode and method thereof

(75) Inventors: Jin-young Lee, Suwon-si (KR); Sang-hyup Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/581,426

(22) Filed: Oct. 17, 2006

(30) Foreign Application Priority Data
Dec. 9, 2005 (KR) 2005-120862

(51) Int. Cl. G06F 15/16

(52) U.S. Cl. 709/229

(57) ABSTRACT

An image forming device in communication with at least one host apparatus through a network. The image forming device includes an engine unit to perform an image forming operation, a password generating unit to generate a password, a password transmitting unit to transmit the password to at least one host apparatus, a user interfacing unit to receive a control command and an input password, and a controlling unit to control the engine unit to perform the image forming operation corresponding to the control command when the input password received through the user interfacing unit and the password generated by the password transmitting unit correspond to each other. Accordingly, a risk of the password becoming known by unauthorized users is minimized.

### CROSS-REFERENCE TO RELATED APPLICATIONS

This application claims the benefit under 35 U.S.C. § 119(a) of Korean Patent Application No. 2005-120862, filed Dec. 9, 2005, in the Korean Intellectual Property Office, the entire contents of which are incorporated herein by reference.

### BACKGROUND OF THE INVENTION

1. Field of the Invention

The present general inventive concept relates to an image forming device and a method thereof. More particularly, the present general inventive concept relates to an image forming device and a method thereof, which creates an arbitrary password using a random process and provides the created password to a host apparatus in communication with a network in a variety of ways.

2. Description of the Related Art

Network technological advances have led to developments and distributions of various network devices. One example of these developed network devices is a network image forming device. The network image forming device is an image forming device having a network interfacing card that transmits and receives data with a personal computer and a lap top connected through a network.

The image forming device connected through network is shared by a large number of users, characteristic thereof. An unauthorized user may use the image forming device by connecting his or her personal computer through the network and registering an IP (information provider) of the image forming device. Setting a password at the image forming device is generally used to prevent the unauthorized user (e.g., a third party) unaware of the password from using the image forming device.

In a conventional image forming device, a user decides and inputs an arbitrary password in person when registering his or her ID to the image forming device. In this process, the user typically uses particular numbers or letters related to the user (i.e., user-specific identifiers) to select the password. Accordingly, the password may be obvious or easily decipherable to others. If the password becomes known to the third party or unauthorized user, the third party may freely use the password for printing, duplicating, and scanning.

Additionally, the user may forget his or her password. In this case, the user is required to register a new ID and a new password with the image forming device.

### SUMMARY OF THE INVENTION

The present general inventive concept provides an image forming device which reduces a risk of a password becoming known by unauthorized users by generating the password using a random process and directly providing the generated password to a host apparatus so that a user of the host apparatus can perform an authentication operation using the password.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an image forming device including an engine unit to perform an image forming operation, a password generating unit to generate a password, a password transmitting unit to transmit the password to at least one host apparatus, a user interfacing unit to receive a control command and an input password, and a controlling unit to control the engine unit to perform the image forming operation corresponding to the control command when the input password received through the user interfacing unit and the password generated by the password transmitting unit correspond to each other.

The password may be transmitted by at least one of a SMS (short message service), an email (electronic mail), a fax, and a messaging application.

The image forming operation includes at least one of a printing operation, a scanning operation, a duplicating operation and a faxing operation.

The image forming device may further include a data receiving unit to receive a printing data associated with a user password from a requesting host apparatus, and the controlling unit controls the engine unit to print the printing data, when the user password associated with the printing data and the password generated by the password generating unit correspond to each other.

The image forming device may further include a storing unit to store information about a target host apparatus in communication with the network, and the controlling unit controls the password transmitting unit to transmit the password only to the target host apparatus of the at least one host apparatus.

The controlling unit may store information about a first host apparatus in the storing unit, when a target designation command is input through the user interfacing unit to designate the first host apparatus as the target host apparatus.

The controlling unit may store a password character information in the storing unit when the password character information is input through the user interfacing unit to designate a length of the password, a composition of the password, and a regeneration cycle of the password.

The password generating unit generates the password of the length and the composition designated by the password character information, and generates the password once during each regeneration cycle designated by the password character information.

The controlling unit may create a password transmission history list recorded with at least one of information about the target host apparatus to which the password is transmitted, a number of times the password has been transmitted, and information about a re-transmitted password.

The controlling unit may control the password generating unit to regenerate the password when confirming the password transmission history list and determining that the password generated by the password generating unit and a re-generated password correspond to each other.

The password generating unit generates the password using a random process.

The foregoing and/or other aspects of the present general inventive concept may also be achieved by providing an image forming device, including an engine unit to perform one or more predetermined operations, a password generating unit to periodically generate a current password during each of a plurality of password cycles, an interfacing unit to receive an input password associated with a request to perform the one or more predetermined operations, and a control unit to control the engine unit to perform the one or more predetermined operations when the input password matches the current password.

The foregoing and/or other aspects of the present general inventive concept may also be achieved by providing an image forming device, including a password generating unit to update a device password according to a periodic cycle, and a control unit to authorize access to device operations when the updated device password is provided at an input and to prevent access when the updated device password is not provided at the input.

The foregoing and/or other aspects of the present general inventive concept may also be achieved by providing a printing system, including a network, one or more host apparatuses in communication with the network, and an image forming device in communication with the network. The image forming device includes an engine unit to perform one or more predetermined operations, a password generating unit to periodically re-generate a current password during each of a plurality of predetermined password cycles, an interfacing unit to receive an input password associated with a request to perform the one or more predetermined operations, and a control unit to control the engine unit to perform the one or more predetermined operations when the input password matches the current password.

The foregoing and/or other aspects of the present general inventive concept may also be achieved by providing a method of forming an image in an image forming device in communication with at least one host apparatus through a network, the method including generating a password, transmitting the password to at least one host apparatus, receiving a control command and an input password through a user interfacing unit provided in the image forming device, comparing the input password and the password transmitted to the at least one host apparatus, and performing an image forming operation corresponding to the control command when the input and transmitted passwords correspond to each other.

The transmitting of the password may include transmitting the password by at least one of a SMS(short message service), an email (electronic mail), a fax, and a messaging application.
The image forming operation may include at least one of a printing operation, a scanning operation, a duplicating operation and a faxing operation.

The method may further include receiving a printing data associated with a user password from a requesting host apparatus, and printing the printing data when the user password associated with the printing data and the password generated by the password generating unit correspond to each other.

The method may further comprise receiving a target designation command to designate a target host apparatus of at least one host apparatus through the user interfacing unit, and storing information about the target host apparatus designated by the target designation command, and the transmitting of the password includes transmitting the password to the target host apparatus.

The method may further include receiving and storing a password character information to designate a password length, a password composition, and a regeneration cycle of the password through the user interfacing unit, and the generating of the password includes generating the password of the password length and the password composition according to the stored password character information.

The method may further include creating and storing a password transmission history list recorded with at least one of information about the host apparatus to which the password is transmitted, a number of times the password has been transmitted, and information about a re-transmitted password.

The method may further include confirming the password transmission history list and comparing the generated password and a pre-generated password, and regenerating the password when the generated password and the pre-generated password correspond to each other.

The password may be generated using a random process.

The foregoing and/or other aspects of the present general inventive concept may also be achieved by providing a computer readable medium containing executable code to control an image forming device having an engine unit that performs one or more predetermined operations, the medium including an executable code to periodically re-generate a current password during each of a plurality of predetermined password cycles, an executable code to receive an input password associated with a request to perform the one or more predetermined operations, and an executable code to control the engine unit to perform the one or more predetermined operations when the input password matches the current password.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a diagram illustrating a printing system according to an embodiment of the present general inventive concept;

FIGS. 2 and 3 are block diagrams illustrating examples of an image forming device used by the printing system of FIG. 1;

FIG. 4 is a flowchart illustrating a method of forming an image according to an embodiment of the present general inventive concept; and

FIG. 5 is a flowchart illustrating a method of forming an image according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

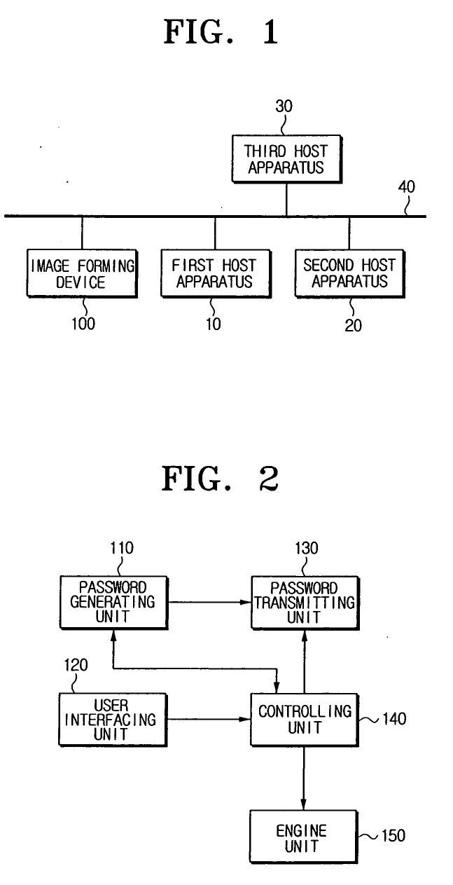

FIG. 1 is a diagram illustrating a printing system according to an embodiment of the present general inventive concept. Referring to FIG. 1, the printing system includes an image forming device 100 and a first through a third host apparatuses (10 through 30). The image forming device 100 and the first through the third host apparatuses (10 through 30) are connected through a network 40, respectively. The network 40 may be implemented as a wireless LAN (local area network) or a wire LAN (local area network). The image forming device 100 may be a printer, a scanner and a duplicator, a MFP (multi function printer), or other devices. The first through the third host apparatuses (10 through 30) may be a personal computer, a lap top, or a PDA (personal digital assistant), among other devices. FIG. 1 illustrates three host apparatuses (10 through 30), however it should be understood that the number of host apparatuses is not limited to three and can be greater than or less than three.

The image forming device 100 generates a password (or passcode) using a random process every predetermined cycle. A length, a composition, and a regeneration cycle of the password may be arbitrarily set by a user. Alternatively, these parameters may be preset or designated as a default value. That is, if a four-digit length, a combination composition between numbers and English letters, and a 1-day cycle are set for the password, the image forming device 100 generates a 4-digit password including a combination of numbers and English letters everyday.

The image forming device 100 transmits the generated password to the first through the third host apparatuses (10 through 30) through the network 40. The first through the third host apparatuses (10 through 30) inform a user thereof about the received password such that the user can recognize the password. Accordingly, the user of the first through the third host apparatuses (10 through 30) uses the password transmitted thereto to perform a user authentication operation or other operations.

The user completes (e.g., by creating or editing) printing data and adds a password (e.g., a user password or an input password) to the printing data to input a control command for printing. That is, the user associates the password with the printing data. The image forming device 100 compares the password added to the printing data and the password generated and transmitted to the first through the third host apparatuses (10 through 30). When the password added to the printing data and the generated and transmitted password correspond to each other, the image forming device 100 prints the printing data.

When the image forming device 100 is realized as a scanner, a duplicator, a facsimile, or the MFP, the user typically visits the image forming device 100 to scan, duplicate (i.e., copy), or fax. The user manipulates various keys or a LCD (liquid crystal display) panel provided in the image forming device 100 to input his or her password.

When the input password and the password generated and transmitted to the first through the third host apparatuses (10 through 30) correspond, the image forming device 100 performs a scanning, a duplicating and a faxing operations. When the input password does not correspond to the generated and transmitted password, the image forming device 100 prints a warning message and/or outputs a warning sound informing the user about his or her not being authorized or permitted to use the image forming device 100.

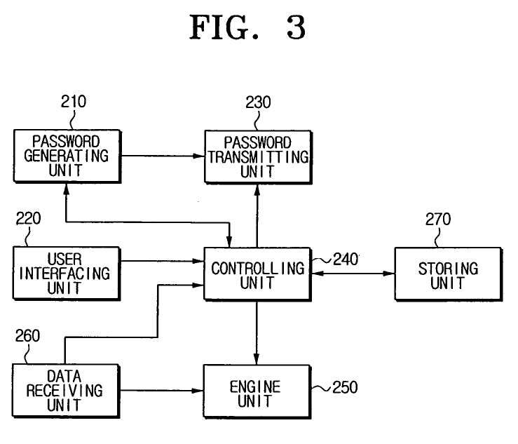

FIG. 2 is a block diagram illustrating an example of an image forming device 100 used by the printing system of FIG. 1. Referring to FIG. 2, the image forming device 100 includes a password generating unit 110, a user interfacing unit 120, a password transmitting unit 130, a controlling unit 140, and an engine unit 150.

The password generating unit 110 generates a password using a random process. As described above, the length and the composition of the password may be set by a user or decided as a default value. The random process is to arbitrarily set and arrange letters and numbers to be placed at each digit of the password.

The user interfacing unit 120 provides an interface where a user inputs various control commands to control the image forming device 100 or to provide a password. More particularly, the user interfacing unit 120 may be a key pad and/or a LCD (liquid crystal display) touch screen.

The password transmitting unit 130 transmits the password generated by the password generating unit 110 to the host apparatuses 10 through 30 (see FIG. 1) in communication with the network 40. More particularly, the password may be transmitted to the user in a variety of ways such as a SMS (short message service), a fax, an email, and/or a messenger program and other application. When a target host apparatus is specifically designated, the password may be transmitted specifically to the target host apparatus instead of all the host apparatuses 10 through 30. This will be explained in another embodiment of the present general inventive concept (below).

The controlling unit 140 controls the password generating unit 110 to regenerate the password every preset cycle (i.e., regeneration cycle) and controls the password transmitting unit 130 to transmit the regenerated password to the host apparatuses 10 through 30. The controlling unit 140 performs a controlling operation every regeneration cycle, which is determined by a user's setting value or a default value. Accordingly, it is possible to internally generate and, at any time, provide the password to be used to each of the host apparatuses 10 through 30 such that a risk of password becoming known by unauthorized users can be minimized. Additionally, there is no need to register a new password when the user forgets the password.

The controlling unit 140 stores the password generated using the random process in a memory (not shown). Accordingly, whenever the user inputs various control commands to control the image forming device 100 through the user interfacing unit 120, the controlling unit 140 uses the password stored in the memory to authenticate the user.

The engine unit 150 performs the scanning operation, the faxing operation, the duplicating operation, and the printing operation under the control of the controlling unit 140. More particularly, the engine unit 150 may include a printing module (not shown) and a scanning module (not shown). Accordingly, the printing module is driven to perform the printing operation and the scanning module is driven to perform the scanning operation or the faxing operation. The printing and scanning modules are driven to perform the duplicating operation. Since the functions and constructions of engine unit 150 are well-known to one of ordinary skill in the art, a detailed description thereof will not be provided here.

The controlling unit 140 requests the password to be input when the control command to control the image forming device 100 is input to request a predetermined operation through the user interfacing unit 120. More particularly, a message is displayed to request the password to be input using a LCD (liquid crystal display) monitor or a speaker provided in the user interfacing unit 120. Accordingly, if the user inputs the password, the input password is compared with the password stored in the memory. If the two passwords are determined to correspond to one another, the scanning operation, the faxing operation, the printing operation, and/or the duplicating operation can be performed under the control of the control command input by the user.

The controlling unit 140 may print or display a message requesting the password to be input when a printer cover of the image forming device 100 is touched, or when an arbitrary key is selected. Accordingly, a user authentication may be performed. For example, when the printer cover is removed to replace a consumable part or install/remove a part or when the user interfacing unit 120 detects that a predetermined operation is being requested using the arbitrary key, the user may be prompted for the password.

FIG. 3 is a block diagram illustrating another example of an image forming device 100 used in the printing system of FIG. 1.

The image forming device 100 of FIG. 3 includes a password generating unit 210, a user interfacing unit 220, a password transmitting unit 230, a controlling unit 240, an engine unit 250, a data receiving unit 260, and a storing unit 270.

The password generating unit 210 generates a password using a random process.

The password transmitting unit 230 transmits the generated password to external host apparatuses 10 through 30 (see FIG. 1). The user interfacing unit 220 provides an interface for a user to input various control commands to control the image forming device 100. The engine unit 250 is a mechanical component that performs an image forming operation such as duplicating, scanning, faxing, and/or printing.

The password generating unit 210, the user interfacing unit 220, the password transmitting unit 230, and the engine unit 250 are similar to the corresponding components of the embodiment of FIG. 2. Accordingly, a detailed description of these components will not be provided here.

The user interfacing unit 220 may receive various data related to password generation. More particularly, the user interfacing unit 220 may receive a password character information and a target designation command.

The password character information is input to newly set password characters (i.e., reset the password and/or parameters associated with the password) such as the length, the composition, and the regeneration cycle of the password. If the password character information is input, the controlling unit 240 stores the input information in the storing unit 270. Accordingly, the password generating unit 210 is controlled to regenerate the password once every regeneration cycle according to the newly set password character information. The password generating unit 210 regenerates the password of the length and the composition according to the newly set password character information.

The target designation command designates a target host apparatus(es) to which the password is to be transmitted from among all of the host apparatuses 10 through 30 connected to the network 40 (see FIG. 1).

When the target designation command is input to designate the target host apparatus(es), the controlling unit 240 creates an information list about the designated host apparatus and stores the information list in the storing unit 270.

Accordingly, the password transmitting unit 230 confirms the list and may transmit the password only to the target host apparatus(es). The password transmitting unit 230 may transmit the password to the user in a variety ways, such as a SMS (short message service), a fax and an email using a user telephone number, a user email address, a user IP (information provider) address, and/or a fax number among target host apparatus information stored in the storing unit 270.

The controlling unit 240 may create a list including a password transmission history and store the list in the storing unit 270. The password transmission history includes information about previous target host apparatus(es) to which the password has been transmitted, a number of password transmissions, information about a previously transmitted password and a password transmission time.

The storing unit 270 includes a storing area associated with password character information, a storing area associated with the target host apparatus information and list, and a storing area associated with the password transmission history list.

The data receiving unit 260 receives printing data from an external host apparatus for printing. That is, the user creates the printing data and inputs a pre-informed password through his or her host apparatus. The pre-informed password may be previously transmitted to the user's host apparatus. Accordingly, the input password is added to the printing data and received through the data receiving unit 260. The input password may be associated with the printing data to authenticate the user when the user requests that the image forming device 100 perform the printing operation. The controlling unit 240 compares the received password (i.e., an input password) and a pre-stored password (i.e., the generated password), and an authentication operation is performed. Once the received password associated with the printing data authenticates the user, the printing data is printed.

Although the embodiment of FIG. 3 illustrates that the data receiving unit 260 and the user interfacing unit 220 are separate units of the image forming device 100, it should be understood that these components may be combined into one unit (e.g., an interface unit) which receives the input password either by transmission along with the printing data or at the image forming device.

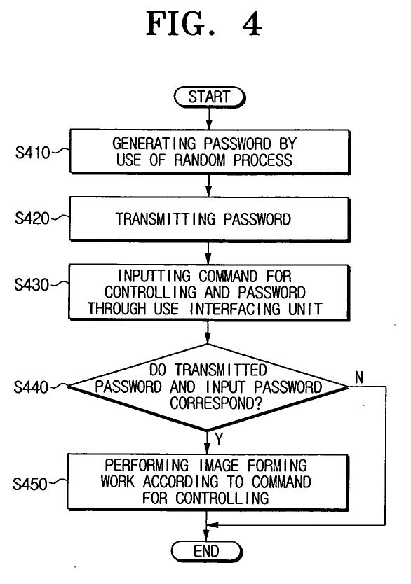

FIG. 4 is a flowchart illustrating a method of generating a password according to an embodiment of the present general inventive concept. The method of FIG. 4 may be performed in the printing system of FIG. 1, and may be performed by the image forming device 100 of FIGS. 2 or 3. Referring to FIG. 4, a password is generated using a random process (operation S410) and the password is transmitted to a host apparatus connected through a network (operation S420). If a command to control an image forming device to perform a predetermined operation and a password are input through a user interfacing unit in this state (operation S430), a pre-generated and transmitted password is compared with the input password. It is then determined whether the two passwords correspond to each other (operation S440). If the two passwords correspond, an image is formed according to the control command input at the user interfacing unit (operation S450).

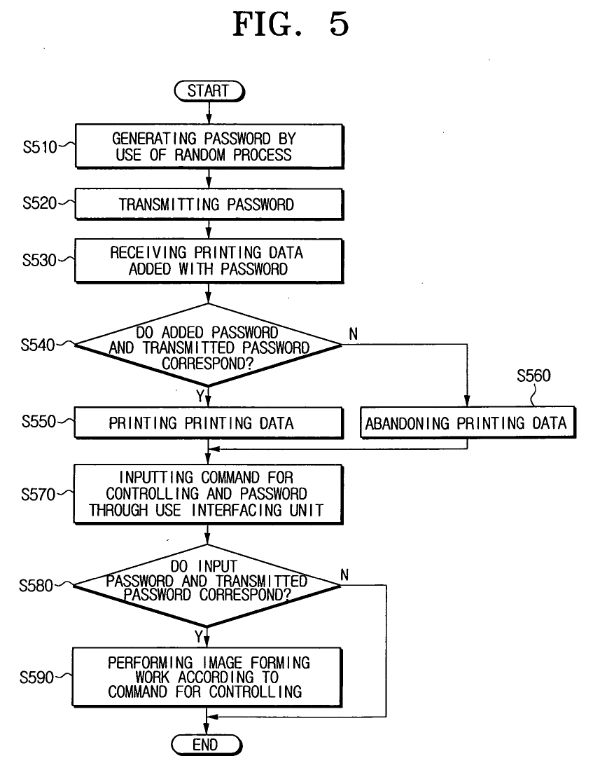

FIG. 5 is a flowchart illustrating a method of generating a password according to another embodiment of the present general inventive concept. The method of FIG. 5 may be performed in the printing system of FIG. 1, and may be performed by the image forming device 100 of FIGS. 2 or 3. A method of generating a password of FIG. 5 generates the password using a random process (operation S510), and transmits the generated password to a plurality of host apparatuses (operation S520). Alternatively, the password may be transmitted to a target host apparatus selected from among the plurality of host apparatuses.

If printing data added associated with an input password is received from one of the host apparatuses (operation S530), it is determined whether the input password associated with the printing data and the transmitted password correspond to one another (operation S540).

When the two passwords are determined to correspond, the printing data is printed (operation S550). When the two passwords are determined not to correspond, the printing data is not printed (i.e., abandoned) (operation S560).

According to the present embodiment, when a command to control an image forming device is input through a user interfacing unit thereof (operation S570), an authentication operation is performed. That is, the control command and a password are input through the user interfacing unit, and the input password is compared with a previously transmitted password (operation S580). When the two passwords correspond, an image is formed according to the control command. When the two passwords do not correspond, no operation is performed by the image forming device and/or a warning message may be displayed or printed. Thus, in the method of FIG. 5, the input password may be input in two different ways. First, the input password can be provided by a host apparatus requesting an image forming operation along with the printing data to be printed. Second, the input password may be provided at the user interfacing unit when a scanning operation, a duplicating operation, or a faxing operation is requested.

The present general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present general inventive concept can be easily construed by programmers skilled in the art to which the present general inventive concept pertains.

As described above, according to embodiments of the present general inventive concept, a password is internally generated by an image forming device and is provided to a host apparatus(es) in a variety of ways.

Accordingly, a risk associated with having a password may be reduced. Also, it is possible to prevent a third party (or unauthorized user) from discovering a password by generating the password using a random process. Also, a user does not need to newly register the password even when the user forgets the password, because the password is periodically retransmitted to the user and/or a host apparatus of the user. Accordingly, a user convenience is enhanced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming device in communication with at least one host apparatus through a network, the device comprising:
an engine unit to perform an image forming operation;
a password generating unit to generate a password;
a password transmitting unit to transmit the password to the at least one host apparatus;
a user interfacing unit to receive a control command and an input password; and
a controlling unit to control the engine unit to perform the image forming operation corresponding to the control command, when the input password received through the user interfacing unit and the password generated by the password transmitting unit correspond to each other.

2. The image forming device of claim 1, wherein the generated password is transmitted by one of a SMS (short message service), an email (electronic mail), a fax, and a messaging application.

3. The image forming device of claim 2, wherein the image forming operation includes at least one of a printing operation, a scanning operation, a duplicating operation, and a faxing operation.

4. The image forming device of claim 3, further comprising:
a data receiving unit to receive a printing data associated with a user password from a requesting host apparatus;
wherein the controlling unit controls the engine unit to print the printing data, when the user password associated with the printing data and the password generated by the password generating unit correspond to each other.

5. The image forming device of claim 4, further comprising:
a storing unit to store information about a target host apparatus in communication with the network;
wherein the controlling unit controls the password transmitting unit to transmit the password only to the target host apparatus of the at least one host apparatus.

6. The image forming device of claim 5, wherein the controlling unit stores information about a first host apparatus in the storing unit when a target designation command is input through the user interfacing unit to designate the first host apparatus as the target host apparatus.

7. The image forming device of claim 6, wherein the controlling unit stores a password character information in the storing unit when the password character information is input through the user interfacing unit to designate a length of the password, a composition of the password, and a regeneration cycle of the password.

8. The image forming device of claim 7, wherein the password generating unit generates the password of the length and the composition designated by the password character information, and generates the password once during each regeneration cycle designated by the password character information.

9. The image forming device of claim 5, wherein the controlling unit creates a password transmission history list recorded with at least one of information about the target host apparatus to which the password is transmitted, a number of times the password has been transmitted, and information about a re-transmitted password.

10. The image forming device of claim 9, wherein the controlling unit controls the password generating unit to regenerate the password when confirming the password transmission history list and determining that the password generated by the password generating unit and a re-generated password correspond to each other.

11. The image forming device of claim 1, wherein the password generating unit generates the password using a random process.

12. An image forming device, comprising:
an engine unit to perform one or more predetermined operations;
a password generating unit to periodically generate a current password during each of a plurality of password cycles;
an interfacing unit to receive an input password associated with a request to perform the one or more predetermined operations; and
a control unit to control the engine unit to perform the one or more predetermined operations when the input password matches the current password.

13. The image forming device of claim 12, wherein the interfacing unit comprises a user interfacing part having one or more function keys to receive a control command to request the one or more predetermined operations.

14. The image forming device of claim 12, wherein the interfacing unit comprises a data receiving unit to receive a transmission from a requesting host apparatus, the transmission including printing data associated with the input password and a control command to request the one or more predetermined operations.

15. The image forming device of claim 12, further comprising:
a transmitting unit to transmit the current password to one or more host apparatuses arranged along a network.

16. The image forming device of claim 12, wherein the control unit authorizes a first class of users to control the engine unit, and prevents a second class of users from controlling the engine unit.

17. An image forming device, comprising:
a password generating unit to update a device password according to a periodic cycle; and
a control unit to authorize access to device operations when the updated device password is provided at an input and to prevent access when the updated device password is not provided at the input.

18. A printing system, comprising:
a network;
one or more host apparatuses in communication with the network; and
an image forming device in communication with the network, the device including an engine unit to perform one or more predetermined operations,
a password generating unit to periodically re-generate a current password during each of a plurality of predetermined password cycles,
an interfacing unit to receive an input password associated with a request to perform the one or more predetermined operations, and
a control unit to control the engine unit to perform the one or more predetermined operations when the input password matches the current password.

19. A method of forming an image in an image forming device in communication with at least one host apparatus through a network, a method comprising:
generating a password;
transmitting the password to the at least one host apparatus;
receiving a control command and an input password through a user interfacing unit provided in the image forming device;
comparing the input password and the password transmitted to the at least one host apparatus; and
performing an image forming operation corresponding to the control command when the input and transmitted passwords correspond to each other.

20. The method of forming an image of claim 19, wherein the transmitting of the password comprises transmitting the password by at least one of a SMS(short message service), an email (electronic mail), a fax, and a messaging application.

21. The method of forming an image of claim 20, wherein the image forming operation includes at least one of a printing operation, a scanning operation, a duplicating operation, and a faxing operation.

22. The method of forming an image of claim 21, further comprising:
receiving a printing data associated with a user password from a requesting host apparatus; and
printing the printing data when the user password associated with the printing data and the password generated by the password generating unit correspond to each other.

23. The method of forming an image of claim 22, further comprising:
receiving a target designation command to designate one of the at least one host apparatus through the user interfacing unit; and
storing information about the target host apparatus designated by the target designation command,
wherein the transmitting of the password comprises transmitting the password to the target host apparatus.

24. The method of forming an image of claim 23, further comprising:
receiving and storing a password character information designated with a length of the password, a composition of the password, and a regeneration cycle of the password through the user interfacing unit,
wherein the password is generated to have the length and the composition according to the stored password character information.

25. The method of forming an image of claim 19, further comprising:
creating and storing a password transmission history list recorded with at least one of information about a host apparatus to which the password is previously transmitted, a number of times that the password has been transmitted, and information about a re-transmitted password.

26. The method of forming an image of claim 25, further comprising:
confirming the password transmission history list and comparing the generated password and a pre-generated password; and
regenerating the password when the generated password and the pre-generated password correspond to each other.

27. The method of forming an image of claim 19, wherein the password is generated by a random process.

28. A computer readable medium containing executable code to control an image forming device having an engine unit that performs one or more predetermined operations, the medium comprising:
an executable code to periodically re-generate a current password during each of a plurality of predetermined password cycles;
an executable code to receive an input password associated with a request to perform the one or more predetermined operations; and
an executable code to control the engine unit to perform the one or more predetermined operations when the input password matches the current password.
